(19) United States
(12) Patent Application Publication
(10) Pub. No.: US 2016/0129851 A1
(43) Pub. Date: May 12, 2016

(54) VEHICLE DOOR WITH CONTROL PANEL

(71) Applicant: GM GLOBAL TECHNOLOGY OPERATIONS LLC, Detroit, MI (US)

(72) Inventor: Matthias WERNER, Ginsheim (DE)

(73) Assignee: GM GLOBAL TECHNOLOGY OPERATIONS LLC, Detroit, MI (US)

(21) Appl. No.: 14/935,858

(22) Filed: Nov. 9, 2015

(30) Foreign Application Priority Data
Nov. 8, 2014 (DE) 102014016570.1

(51) Int. Cl. B60R 11/02; G06F 3/041; B60J 5/04

(52) U.S. Cl. CPC B60R 11/0264; B60J 5/0493; B60R 11/0241; B60R 11/0235; G06F 3/0416; B60R 2011/0021

(57) ABSTRACT

A control panel realized in the form of a touchscreen is arranged on an inner side of a vehicle door. The control panel can be switched over between at least two display modes. The touchscreen displays a first control element for controlling a first actuator of the vehicle in the first control mode and a second control element for controlling a second actuator, which is dissimilar from the first actuator, in the second control mode. The control panel may include a touchscreen of a smartphone device operably positioned in a recess formed in qn interior trim panel of the vehicle door.

### CROSS-REFERENCE TO RELATED APPLICATION

This application claims priority to German Patent Application No. 102014016570.1, filed Nov. 8, 2014, which is incorporated herein by reference in its entirety.

### TECHNICAL HELD

The present disclosure pertains to a door for a vehicle with an integrated control panel for controlling actuators such as, for example, servomotors of an exterior rearview mirror that are arranged on the door or at other locations of the vehicle.

### BACKGROUND

A vehicle door of this type is known from DE 10 2005 036 001 A1, which addresses the problem of comfortably controlling functionally identical actuators provided in several sets at different locations of the motor vehicle such as, for example, actuators of a left and a right exterior, rearview mirror, power windows or seat adjusters, with a limited number of control elements. In particular, a selection control element is used to select one of several functionally identical actuators, with a control element, by means of which the motions of the respectively selected actuator can be controlled. In this way, one and the same control element can serve for successively controlling different actuators. This is particularly advantageous if the actuator has several degrees of freedom of motion as it is the case with an exterior rearview mirror because the control element for such an actuator is relatively expensive and has a substantial space requirement. However, this conventional concept cannot be used in instances, in which several functionally dissimilar actuators have to be controlled and their potential motions cannot be intuitively associated with the degrees of freedom of the assigned control element.

### SUMMARY

In accordance with the present disclosure, a door for a motor vehicle is provided with an integrated control panel that also enables comfortable control of functionally dissimilar actuators within a confined space.

According to an embodiment of the present disclosure, a vehicle door features a control panel arranged on the inner side thereof. The control panel is realized in the form of a touchscreen that can be switched over between at least two display modes. The touchscreen displays a first control element for controlling a first actuator of the vehicle in the first display mode and a second control element for controlling a second actuator, which is dissimilar from the first actuator, in the second display mode. The touchscreen makes it possible to respectively realize the different control elements dissimilar such that their potential controls can be intuitively associated with the potential motions of the actuators. The respectively displayed control element furthermore enables the user to ascertain the current display mode of the control panel and whether an actuation of the displayed control element can lead to the desired reaction or the control panel initially needs to be switched over into a different display mode.

If the number of display modes is small, a selection control element may be additionally displayed in each display mode. This selection control element can be actuated by the user in order to switch into another display mode assigned to the respective selection control element. Alternatively, a selection mode may be provided, in which the control panel displays at least one selection control element for selecting between the first and second display modes.

The actuators controlled by means of the control panel may fulfill various functions in the motor vehicle. For example, they may control the position of an exterior rearview mirror, a seat or a side window, but they may also open or close a door, a hood or trunk lid or a fuel door of the vehicle, as well as lock and unlock such components in the closed position.

In the first and the second display modes, a symbol specific to the respectively active display mode should be visible on the touchscreen such that the user can at all times ascertain which actuators can be controlled in the current display mode. In order to select between functionally identical actuators, the touchscreen may in the first display mode display a selection control element, by means of which the first actuator of a plurality of actuators can be selected.

The touchscreen may be integrally installed into the door. According to an advantageous enhancement, the touchscreen forms part of a mobile device that is removably accommodated in a mount of the vehicle door. Due to its small dimensions on the one hand and its widespread use on the other hand, a smartphone may be considered as such a mobile device.

Since a broad variety of different models of such devices are in use, the mount should include an exchangeable adapter for accommodating the mobile device in a form-fitting fashion.

A charging socket for charging a rechargeable battery of the mobile device is well suited for promoting the willingness of the user to place the respective mobile device into the mount. If the mobile device is a mobile telephone, it should be connected to a hands-free speakerphone when it is positioned in the mount. In this way, it can be simultaneously ensured that a user, who uses the telephone while driving, complies with the applicable laws by carrying on the conversation via the hands-free speakerphone.

The mobile device should be designed for automatically detecting when it is accommodated in the mount. Such a detection may serve different purposes such as, for example, automatically linking the mobile telephone and the hands-free speakerphone. In the context of the present disclosure, the detection of the mobile device being accommodated in the mount particularly should serve to switch the touchscreen into one of the above-described display modes.

The display mode of the touchscreen may furthermore be switched over in accordance with a state of motion of the vehicle. In this context, particularly a display mode that allows the control of doors, hatches or the fuel door of the vehicle may be blocked while the vehicle is in motion in order to preclude an inadvertent actuation of these elements by the user.

### BRIEF DESCRIPTION OF THE DRAWINGS

The present disclosure will hereinafter be described in conjunction with the following drawing figures, wherein like numerals denote like elements.

FIG. 1 shows a side view of the lower part of a motor vehicle door;

FIG. 2 shows a schematic section through a mount for a mobile device;

FIG. 3 shows a top view of the touchscreen in a selection mode;

FIG. 4 shows a top view of the touchscreen in a first control mode;

FIG. 5 shows a top view of the touchscreen in a second control mode;

FIG. 6 shows a top view of the touchscreen in a third control mode;

FIG. 7 shows a top view of the touchscreen in a fourth control mode, and

FIG. 8 shows a top view of the touchscreen in a fifth control mode.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

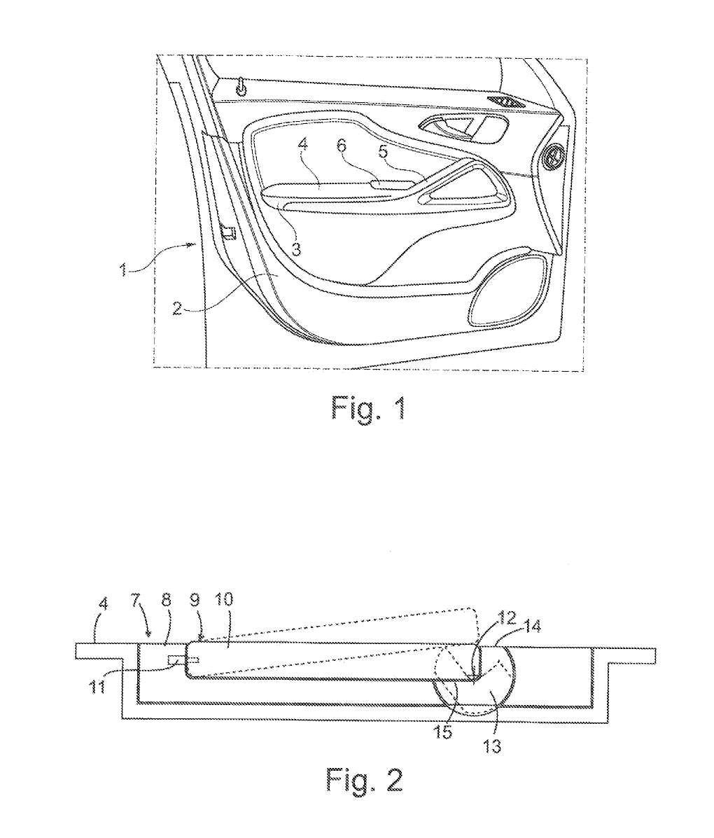

FIG. 1 shows the lower part of a door 1 of a motor vehicle, in this case the driver's door, viewed from its inner side. Interior trim panel 2 of plastic conventionally covers large sections of the door panel. An armrest 3 is formed in a central region of the interior trim panel 2. A handle 5 extends obliquely upward from the horizontal upper side 4 of the armrest 3. A control panel in the form of a touchscreen 6 is arranged in the upper side 4 at the base of the handle 5.

The touchscreen 6 and an assigned control unit may be integrally installed in the door 1, The control unit acts as display driver for the touchscreen 6, detects when and where the touchscreen 6 is contacted by a finger of the user and outputs control commands to actuators of the vehicle derived from the finger contact.

In the example illustrated in FIG. 2, only a recess 7, in which an adapter 8 is detachably accommodated, is integrated into the upper side 4 of the armrest. The adapter 8 in turn features a recess 9 that is adapted to the shape of a smartphone 10 placed therein for holding the smartphone in a form-fitting fashion. The touchscreen of the smartphone serves as the above-described touchscreen 6 and its processor serves as the display driver.

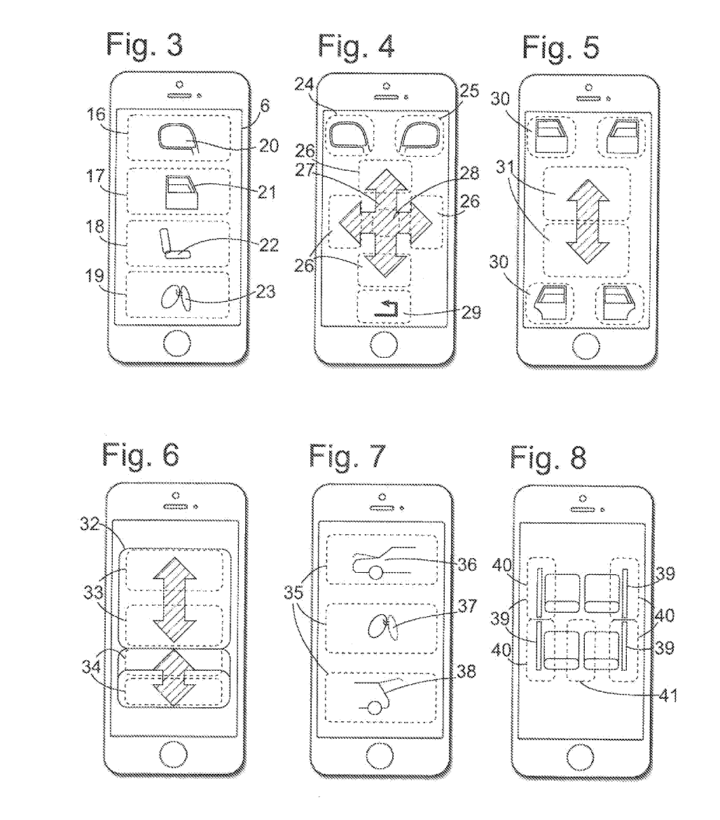

A charging socket 11 of the adapter is coupled to the smartphone 10 in order to connect the smartphone to the vehicle battery and charge its rechargeable battery. The charging socket 11 typically includes a USB connection between the smartphone 10 and other users of an internal network of the vehicle so as to allow data communication there between. When the smartphone is inserted into the recess 9, for example, such a communication with another user enables the smartphone 10 to detect that it is located in a vehicle, as well as to subsequently establish a link with a hands-free speakerphone of the vehicle on the one hand and to start a utility program described in greater detail below with reference to FIGS. 3-8 on the other hand.

An edge of the recess 9 located opposite of the charging socket 10 is in this case formed by a latch 13 that is rotatable about an axis 12 extending perpendicular to the plane of section. The latch encompasses the smartphone 10 in a form-fitting fashion in its position illustrated with continuous lines in FIG. 2 and can be pivoted in the clockwise direction about the axis 12 into an orientation illustrated with broken lines, in which the smartphone 10 is lifted out of the recess 9 by an arm 15 of the latch 13 and can be removed by the user, via pressing on an actuating surface 14.

When the smartphone 10 is inserted into the recess 9 by the user while the vehicle is at a standstill and the smartphone 10 detects this, for example, based on the communication with another user of the vehicle network via the charging socket 11, it initiates an application program, in which it can serve as control element for various actuators of the vehicle.

According to an embodiment, the application program starts with a selection control mode, in which various selection control elements 16-19 are defined on the touchscreen 6 as illustrated in FIG. 3. A user contacting one of these selection control elements 16-19 with a finger is respectively interpreted as inputting a selection command. The boundaries of the control elements 16-19, which are illustrated with broken lines in FIG. 3, do not have to be visible on the touchscreen 6. However, symbols 20-23 are visible within the boundaries of the control elements 16-19 and intuitively reveal to the user which actuators can be accessed with the different control elements 16-19. For example, the servomotors of exterior rearview mirrors of the vehicle are indicated with the symbol 20, power windows with the symbol 21, servomotors of a seat, typically the driver's seat, with the symbol 22 and a fuel door locking mechanism with the symbol 23. Other control elements and symbols may serve for locking doors, a hood or trunk lid of the vehicle or, particularly in the case of a trunk lid, for actuating a servomotor that drives the trunk lid motion.

The link with the on-board network of the vehicle enables the smartphone 10 to detect when the vehicle begins to move. It would be conceivable that individual selection control elements are deactivated when the vehicle is in motion and the symbols assigned thereto preferably are also no longer displayed. This may concern, for example, the control element 19 for the fuel door locking mechanism, which preferably should not be actuatable while the vehicle is in motion. Unlocking or adjusting the hood or trunk lid should also be prevented while the vehicle is in motion.

When the selection control element 16 is actuated, the touchscreen 6 switches over into a first control mode illustrated in FIG. 4. The control elements 24, 25 make it possible to select a left or a right exterior rearview mirror of the vehicle. If applicable, a color change of the corresponding control element 24 or 25 may indicate which of the two exterior rearview mirrors has been selected.

Four additional control elements 26 are defined at the points of an arrow cross 27 illustrated on the touchscreen 6. Two opposite control elements 26 control pivoting motions of the respectively selected exterior rearview mirror about one of two pivoting axes in respectively opposite directions. A control element 28 in the center of the arrow cross 27 may be provided for jointly retracting and extending the exterior rearview mirrors.

A control element 29 may be provided for returning to the selection mode according to FIG. 3. Alternatively, the return to the selection mode could also take place when no contact of the touchscreen 6 by the user is detected during a predefined waiting or idle period or, for example, a command gesture such as a swiping motion over a large portion of the touchscreen is detected instead of the user tapping on an individual control element.

A second control mode illustrated in FIG. 5 is activated by actuating the selection control element 17. Four selection control elements 30 on the corners of the touchscreen 6 are assigned to the four doors of the vehicle and enable the user to specify on which door a power window should be opened or closed by means of large-surface control elements 31 that are centrally positioned on the touchscreen 6.

FIG. 6 shows the touchscreen 6 in a control mode that can be selected by means of the selection control element 18 according to FIG. 3. In this case, control elements 33, 34 are superimposed on a schematic top view of the driver's seat 32. The control elements 33 illustrated on the seating surface control a forward or backward motion of the entire seat 32 and the control elements 34 illustrated on the backrest control the inclination of the latter. Although the driver's seat 32 has in this case two degrees of freedom of motion analogous to the exterior rearview mirrors, the arrangement of the control elements 26 illustrated in FIG. 4 would not allow an intuitive control of the driver's seat 32. The touchscreen 6 makes it possible to always position and, if applicable, combine the control elements with explanatory symbols such as, e.g., 27 or 32 in such a way that an intuitive control can be realized.

The control mode illustrated in FIG. 7 can only be selected by means of the selection control element 19 when the vehicle is at a standstill. The symbols 36, 37, 38 assigned to the control elements 35 in this mode respectively refer to the functions of the corresponding control elements 35 for unlocking a hood, a fuel door or a trunk lid. They may change their appearance depending on the state of actuation, e.g., in that the hood illustrated with broken lines in the symbol 36 is illustrated with continuous lines as soon as the corresponding control element has been actuated and the hood has been unlocked.

FIG. 8 shows another control mode, in which a schematic top view of the passenger compartment of the vehicle is displayed on the touchscreen 6. In this case, the illustrations of the doors 39 serve as symbols that mark the position of control elements 40, by means of which the respective locking mechanism of the corresponding door is controlled. Another control element 41 may be superimposed on the illustration of the rear seats in order to activate and deactivate a child safety lock on the rear doors.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-12. (canceled)

13. A vehicle door comprising a control panel arranged on an inner side of the vehicle door, the control panel having a touchscreen configured to switch between a first control mode wherein the touchscreen displays at least one first control element for controlling a first actuator in the first control mode and a second control mode wherein the touchscreen displays at least one second control element for controlling a second actuator, which is dissimilar from the first actuator, in the second control mode.

14. The vehicle door according to claim 13, wherein the control panel can be switched into a selection mode, wherein the touchscreen displays at least one selection control element for selecting between the first and the second control modes.

15. The vehicle door according to claim 13, wherein the first and second actuators are selected from the group of actuators which control an exterior rearview mirror, a seat, a side window, a door, a door locking mechanism, a hood, a hood locking mechanism, a trunk lid, a trunk lid locking mechanism, a fuel door or a fuel door locking mechanism.

16. The vehicle door according to claim 13, wherein the touchscreen is configured to display a symbol specific to each of the first and second control modes and operable to switch there between.

17. The vehicle door according to claim 13, wherein the touchscreen displays a selection control element at least in the first control mode by means of which the first of a plurality of actuators can be selected.

18. The vehicle door according to claim 13, further comprising a mobile device removably accommodated in a mount of the vehicle door, wherein the touchscreen forms part of the mobile device.

19. The vehicle door according to claim 18, wherein the mount comprises an exchangeable adapter for accommodating one of a plurality of mobile devices in a form-fitting fashion.

20. The vehicle door according to claim 18, wherein the mount comprises a charging socket by means of which a rechargeable battery of the mobile device can be charged.

21. The vehicle door according to one of claim 18, wherein the mobile device comprises a mobile telephone which when positioned in the mount is connected to a hands-free speakerphone.

22. The vehicle door according to one of claims 18, wherein the mobile device is configured to detect when the mobile device is accommodated in the mount.

23. The vehicle door according to claim 22, wherein the mobile device is configured to switch the touchscreen into one of the display modes when the mobile device is detecting as being accommodated in the mount.

24. The vehicle door according to claim 13, wherein at least one of the first an second control modes is disabled in accordance with a state of motion of the vehicle.
